(19) United States
(12) Patent Application Publication
(10) Pub. No.: US 2013/0167960 A1
(43) Pub. Date: Jul. 4, 2013

(54) DRAIN CONNECTOR FOR FLUID PROCESSING AND STORAGE CONTAINERS

(71) Applicants: Vishwas Pethe, Shakopee, MN (US); Matthew Kusz, Lincoln, NE (US); Steven Vanhamel, Velm (BE); Sven Stiers, Wange (BE)

(72) Inventors: Vishwas Pethe, Shakopee, MN (US); Matthew Kusz, Lincoln, NE (US); Steven Vanhamel, Velm (BE); Sven Stiers, Wange (BE)

(73) Assignees: ATMI PACKAGING, INC., Danbury, CT (US); ATMI BVBA, Hoegaarden (BE)

(21) Appl. No.: 13/641,697

(22) PCT Filed: Apr. 16, 2011
(86) PCT No.: PCT/US2011/032808

§ 371 Date: Jan. 2, 2013

Related U.S. Application Data
(60) Provisional application No. 61/325,443, filed on Apr. 19, 2010.

(51) Int. Cl. F17C 13/00; F17C 13/04

(52) U.S. Cl. CPC F17C 13/00; F17C 13/04
USPC 137/798; 29/890.124

(57) ABSTRACT

A selectively closeable drain connector includes a hollow body or plunger moveable relative to a bore-defining drain flange. A locking element may be arranged to maintain the hollow body relative to the drain flange in one or more desired positions. At least one sealed jacket may extend between exterior portions of the drain flange and the hollow body to provide a barrier arranged to inhibit passage of contaminants to sealing surfaces along which the hollow body travels relative to the drain flange. The drain connector may be joined to a container, such as a tank, bag, vessel, or other receptacle for material storage and/or processing.

### CROSS-REFERENCE TO RELATED APPLICATION(S)

This application claims benefit of U.S. Provisional Patent Application No. 61/325,443 filed on Apr. 19, 2010.

### TECHNICAL FIELD

The present invention relates to material storage and/or processing containers and drain connectors therefor, including containers used for the processing (e.g., mixing and/or reacting) of various substances in laboratory and industrial settings.

### BACKGROUND

Mixing and/or reacting of components, such as different types of solids, liquids and/or gases, have numerous applications in different industries. For example, in the pharmaceutical industry, different types of drug precursor materials and/or therapeutic agents are mixed and/or reacted. In the medical field, components such as body fluids and/or drugs are mixed and/or reacted. In the semiconductor field, wet solutions are combined with abrasives to make slurries. The food industry also incorporates mixing operations into a number of applications, including the mixing of water with dried food to accomplish rehydration.

In these and other industries, however, the components to be mixed or reacted may be hazardous, dangerous, infectious, and/or require high levels of purity. For example, in the pharmaceutical and/or medical industries, components subject to mixing or reacting operations may be toxic. In the medical field, fluids to be processed may contain live viruses (e.g., HIV) or other pathogens, justifying the need for individuals to avoid contact with such fluids. Furthermore, in the semiconductor industry, handling of chemicals is avoided to reduce the potential for forming particulates and introducing impurities. For these reasons, it is desirable to accomplish mixing or reacting steps in sealed substance processing assemblies fabricated with non-reactive materials.

In substance processing assemblies, it is important to minimize dead volumes (stagnant regions where unmixed components can avoid agitation) for a number of reasons. A first reason to minimize dead volume is to promote thorough or high quality mixing, which is critical to certain applications such as pharmaceutical formulation. Another reason to avoid dead volumes is to reduce the potential for sedimentation of solids. Dead volumes located in or near drain connectors are particularly problematic, since they can lead to undesirable contamination or carryover between processing batches, or if solids are involved then sedimentation can cause clogs or other draining problems that detrimentally affect system reliability.

Drain connectors used with traditional mixing systems are reusable, and typically include a drain tube leading from the tank to a valve or other sealing means. The drain tube represents a dead volume that can inhibit complete mixing and/or permit sedimentation of solids. The above-mentioned washing, sterilizing, and processing operations may be performed with a drain connector in place, but without certainty that the drain connector is absolutely free of contaminants. Alternatively, the drain connector may be disassembled and separately cleaned or sterilized between mixing batches, but at the expense of substantial effort and delay.

Single-use (e.g., disposable) processing containers and bags have been developed to eliminate need for cleaning and sterilization of conventional processing tanks. In manufacture and/or use of processing containers or processing bags, it may be challenging to adapt a processing container or processing bag to an existing system of fluid conduits. It would be desirable to provide flexibility in configuring inlets and/or outlets of a processing container or processing bag different functions while minimizing the number of fluid connections and adapters, such as to provide valve utility, or to provide unvalved supply or drain utility. It would also be desirable to provide a low dead volume drain connector for a mixing assembly, and that may be sterilized together with an associated mixing assembly.

Certain limitations associated with traditional drain connectors have been overcome by drain connectors disclosed in U.S. Pat. No. 7,614,607 entitled “Drain connector for substance processing receptacle” and developed by co-inventors of the present application; however, further limitations remain unaddressed. One limitation associated with use of known drain connectors is ensuring that a drain connector remains in a desired state (e.g., whether open or closed). Failure to maintain a drain connector in a desired state can lead to unknown ingress or egress of material into or out of a batch of material undergoing processing, or can inhibit full extraction of material from a substance processing receptacle. Such situations can result in waste of part or all of a batch of material. Another limitation associated with use of known drain connectors is the inability to ensure maintenance of sterile conditions after the connector has been operated, since contaminants may migrate past sealing surfaces upon mechanical operation of the connector. Drain connectors may be manually handled and actuated by operators (to open and close the drain valve thereof), and such manual contact and handling operations provide potential for introducing contaminants proximate to drain sealing surfaces. Another limitation associated with use of known drain connectors is that it is cumbersome to mate same with outlet lines of varying sizes to meet varying user requirements without utilizing piping adapters that may compromise sealing integrity and/or sterility, and without utilizing a multiplicity of different drain flanges of different sizes (which are expensive and cumbersome to fabricate and store). The art therefore would benefit from improved drain connectors for processing receptacles.

### SUMMARY

The present invention relates to improved drain connectors for fluid processing apparatuses, and methods utilizing same.

In one aspect, the invention relates to drain connector arranged for mounting to a container having an interior volume, the drain connector comprising: a drain flange defining a bore, the drain flange having a radially extending flange lip adapted for mounting to a wall of said container; a hollow body arranged to move within the bore to selectively affect passage of material to or from the interior volume; and at least one circumferential sealing element disposed between the drain flange and the hollow body; wherein the drain connector further comprises at least one of the following elements (a) and (b): (a) at least one locking element arranged to selectively maintain the hollow body relative to the drain flange in either a first position arranged to permit passage of material to or from the interior volume or a second position arranged to inhibit passage of material to or from the interior volume; and (b) at least one sealed jacket extending between exterior portions of the drain flange and the hollow body to provide a barrier arranged to inhibit passage of contaminants to the at least one circumferential sealing element from an environment exterior to the container.

Another aspect of the invention relates to a method of fabricating a container for processing substances and comprising an interior volume, the method comprising: affixing at least one drain flange to a wall of the container, the at least one drain flange defining a bore of predetermined size; individually selecting for each drain flange of the at least one drain flange, from a plurality of hollow bodies having different outlet sizes, a hollow body of desired outlet size and arranged to move within the bore to selectively affect passage of material to or from the interior volume; for each drain flange of the at least one drain flange, inserting the selected hollow body of desired outlet size into the bore, with at least one circumferential sealing element disposed between the drain flange and the hollow body; and applying at least one sealed jacket extending between exterior portions of the drain flange and the hollow body to provide a barrier arranged to inhibit passage of contaminants to the at least one circumferential sealing element from an environment exterior to the container.

In another aspect, the invention relates to a method utilizing a drain connector mounted to a container having an interior volume, the drain connector comprising drain flange defining a bore, a hollow body arranged to move within the bore to selectively affect passage of material to or from the interior volume, and at least one circumferential sealing element disposed between the drain flange and the hollow body, the method comprising: blocking passage of contaminants to the at least one circumferential sealing element from an environment exterior to the container utilizing at least one sealed jacket extending between exterior portions of the drain flange and the hollow body to provide a barrier arranged to block said passage of contaminants; and moving the hollow body relative to the drain flange between a first position arranged to permit passage of material to or from the interior volume or a second position arranged to inhibit passage of material to or from the interior volume, wherein the sealed jacket is arranged to permit said movement while maintaining said barrier arranged to block said passage of contaminants.

In a further aspect, the invention relates to a method utilizing a drain connector mounted to a container having an interior volume, the drain connector comprising drain flange defining a bore, a hollow body arranged to move within the bore to selectively affect passage of material to or from the interior volume, and at least one circumferential sealing element disposed between the drain flange and the hollow body, the method comprising: moving the hollow body relative to the drain flange between a first position arranged to permit passage of material to or from the interior volume or a second position arranged to inhibit passage of material to or from the interior volume; and operating at least one locking element to maintain the hollow body relative to the drain flange in either the first position or the second position.

In another aspect, any one or more of the foregoing aspects and additional features disclosed herein may be combined for additional advantage.

Other aspects, features and embodiments of the invention will be more fully apparent from the ensuing disclosure and appended claims.

### BRIEF DESCRIPTION OF THE DRAWINGS

FIG. 1 is a perspective view of a first processing container (e.g., tank, bag, vessel, or other receptacle) that is cylindrical in shape and suitable for use with a drain connector according to the present invention, with the container including a hollow sleeve containing a mixing element and an associated support rod, with features interior to the container represented in broken lines.

FIG. 2 is a perspective view of a second processing container that is cylindrical in shape and suitable for use with three drain connectors according to the present invention, with the container including a hollow sleeve containing a mixing element and an associated support rod, and with features internal to the various external structures represented in broken lines

FIG. 3 is a perspective view of a third processing container that is rectangular cubic in shape and suitable for use with at least one drain connectors according to the present invention.

FIG. 4A is an elevation view of a hollow plunger, drain flange, and locking collar of a drain connector in a closed and unlocked state according to one embodiment of the present invention, with the hollow plunger having an internal core of approximately constant internal cross-sectional area or diameter.

FIG. 4B is an elevation view of the hollow plunger, drain flange, and locking collar of the drain connector of FIG. 4A in an open and locked state.

FIG. 4C is a side cross-sectional view of the hollow plunger, drain flange, and locking collar of the drain connector of FIGS. 4A-4B in a closed and locked state.

FIG. 4D is a side cross-sectional view of the hollow plunger, drain flange, and locking collar of the drain connector of FIGS. 4A-4C in an open and locked state.

FIG. 4E is an elevation view of the hollow plunger, drain flange, and locking collar of the drain connector of FIGS. 4A-4D in a closed and locked state (i.e., the same state as shown in FIG. 4C).

FIG. 5A is a perspective view of the hollow plunger illustrated in FIGS. 4A-4E.

FIG. 5B is a side cross-sectional view of the hollow plunger of FIG. 5A.

FIG. 5C is a side cross-sectional view of the hollow plunger of FIGS. 5A-5B coupled to an outlet tube.

FIG. 6A is a perspective view of the drain flange illustrated in FIGS. 4A-4E, oriented upside-down compared to the drain flange orientation shown in FIGS. 4A-4E.

FIG. 6B is a side cross-sectional view of the drain flange of FIG. 6A, oriented the same as the drain flange shown in FIGS. 4A-4E.

FIG. 7A is a perspective view of the locking collar shown in FIGS. 4A-4E.

FIG. 7B is a side cross-sectional view of the locking collar of FIG. 7A.

FIG. 8A is an elevation assembly view of two portions of a hollow plunger for use with drain flange and locking collar according to another embodiment of the present invention, with the hollow plunger including an upper hollow core portion with a first internal cross-sectional area or diameter, and a lower hollow core portion with a second, smaller internal cross-sectional area or diameter.

FIG. 8B is an elevation view of the hollow plunger of FIG. 8A in an assembled state.

FIG. 8C is a side cross-sectional assembly view of the two portions of the hollow plunger of FIG. 8A.

FIG. 8D is a side cross-sectional view of the hollow plunger of FIG. 8B.

FIG. 9A is a side cross-sectional view of a hollow plunger, drain flange, and locking collar of a drain connector in a closed and locked state according to one embodiment of the present invention, including the hollow plunger of FIGS. 8A-8D, the flange of FIGS. 6A-6B, and the locking collar of FIGS. 7A-7B.

FIG. 9B is a side cross-sectional view of a hollow plunger, drain flange, and locking collar of the drain connector of FIG. 9A in an open and locked state.

FIG. 9C is an elevation view of the hollow plunger, drain flange, and locking collar of the drain connector of FIGS. 9A-9B in a closed and locked state.

FIG. 10 is an elevation view of the hollow plunger, drain flange, and locking collar of the drain connector shown in FIG. 4E, with the drain flange joined to a wall of a container (shown in cross-sectional view), and further including at least one external sealed jacket (shown in cross-sectional view) engaged to a portion of each of the hollow plunger, the drain flange, and the locking collar.

FIG. 11 is an elevation view of the hollow plunger, drain flange, and locking collar of the drain connector shown in FIG. 9C, with the drain flange joined to a wall of a container (shown in cross-sectional view), and further including at least one external sealed jacket (shown in cross-sectional view) engaged to a portion of each of the hollow plunger, the drain flange, and the locking collar.

FIG. 12A an elevation view of a hollow plunger (with internal structures shown in dashed lines) superimposed with a cross-sectional view of a drain flange of a drain connector in a closed state according to one embodiment of the present invention, with the drain flange joined to a wall of a container (shown in cross-sectional view) and further including an external sealed jacket (shown in cross-sectional view) engaged to a portion of each of the hollow plunger and the drain flange.

FIG. 12B is an elevation view of the hollow plunger superimposed with a cross-sectional view of the drain flange of the drain connector of FIG. 12A in an open state.

### DETAILED DESCRIPTION

The disclosures of the following patents/applications are hereby incorporated by reference as if set forth herein: U.S. Pat. No. 7,249,880 entitled “Flexible mixing bag for mixing solids, liquids and gases;” U.S. Pat. No. 7,083,323 entitled “Flexible mixing bag for mixing solids, liquids and gases,” and U.S. Pat. No. 7,614,607 entitled “Drain connector for substance processing receptacle.”

Various shortcomings associated with processing receptacles employing conventional drain connectors are overcome by embodiments of the present invention. In at least one embodiment, passage of contaminants to at least one circumferential sealing element (e.g., O-ring) of a drain connector from an environment external to a container may be inhibited by use of at least one sealed jacket extending between exterior portions of a drain flange and a hollow body arranged to move relative to the drain flange to affect passage of material. In at least one embodiment, a drain connector includes at least one locking element arranged to selectively maintain a hollow body relative to a drain flange in either a first position arranged to permit passage of material to or from the interior volume or a second position arranged to inhibit passage of material to or from the interior volume. In at least one embodiment, a drain flange defining a bore of predetermined size may be utilized in conjunction with any of several hollow bodies arranged to travel within the bore to affect flow of material to or from the interior volume of a container, wherein a plurality of hollow bodies includes hollow bodies differing outlet sizes, each hollow body is individually selected to provide a desired outlet size, and each selected hollow body of desired outlet size is inserted into the bore of a drain flange with at least one circumferential sealing element disposed between the drain flange and the hollow body.

In various embodiments, dead volumes may also be reduced by positioning a drain connector with a closeable portion arranged proximate to (preferably substantially flush against) a wall of a container, thus avoiding the use of a remotely located valve separated from the container by a drain tube.

Drain connectors according to embodiments of the present invention may be used to affect flow of material into or out of a container (e.g., tank, bag, vessel, or other receptacle, such as may be used for material storage and/or processing, including bioprocessing). In preferred embodiments, a container and components of an associated drain connector are fabricated of one or more polymeric materials, such as (but not limited to) low-density polyethylene, high-density polyethylene, polypropylene, polytetrafluoroethylene, poly (ether-ether) ketone, and blends and copolymers of the foregoing materials optionally including additional polymeric components. Drain connector components may be fabricated by molding (e.g., injection molding, rotation molding) machining, or any other suitable manufacturing techniques, with components being subject to fabrication each as one part or as multiple parts subject to assembly. In one embodiment, a container and components of an associated drain connector are fabricated of virgin polymeric material that is substantially free of additives that would otherwise be susceptible to leaching into materials subjected to processing with the receptacle. In one embodiment, a container comprises a processing bag fabricated of polymeric film material. In one embodiment, a container has at least one rigid, semi-rigid, or substantially non-rigid wall. In one embodiment, a container comprises a bioprocessing container or vessel. A container may be supported by one or more external support elements, such as a rigid base (optionally including walls), a support frame, and one/or more support hooks or straps. A container may serve as a processing receptacle and may include one or more mixing elements, such as one or more stirbars, missing paddles, agitators, impellers, and the like. In one embodiment, a mixing element is provided in the form of a mixing paddle supported on a support rod arranged to travel within the interior volume of a container, with a sealed sleeve (e.g., fabricated of a polymeric film) affixed to and disposed within the container to serve as an isolation barrier between the mixing paddle/support rod and the contents of the container. A mixing paddle disposed within a sealed sleeve may be arranged to travel within the interior volume in a straight or curvilinear path without continuous rotation of the paddle, in order to prevent the sleeve from twisting around the paddle and potentially inhibiting paddle motion and/or compromising mechanical integrity of the sleeve.

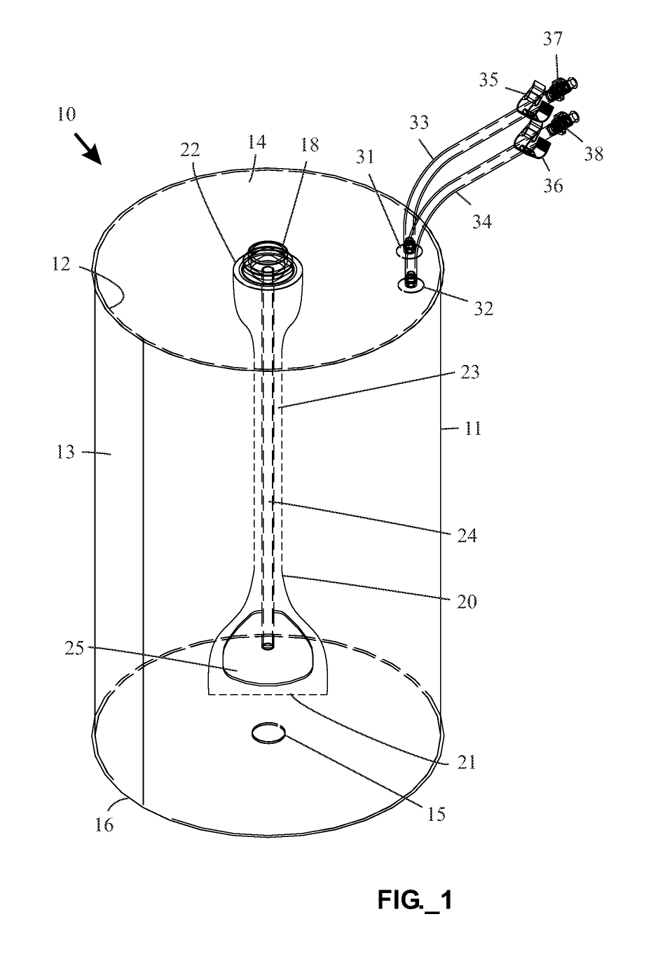

Various exemplary containers (e.g., receptacles for processing and/or storing materials) suitable for use with one or more drain connectors according to embodiments of the present invention are illustrated in FIGS. 1-3.

FIG. 1 illustrates a first container (referred to hereinafter as a container 10 with the understanding that the container 10 may refer to any suitable tank, bag, vessel, or other receptacle, such as may be used for material storage and/or processing, including bioprocessing) for use with a drain connector as described herein is illustrated in FIG. 1. The container 10 includes a cavity-defining sealed sleeve 20 joined to (e.g., the top 404 of) the container 10 and protruding into the interior of the container 10. The cavity 23 of the sleeve 20 contains a mixing paddle 25 and a support rod 24. The sleeve 20 serves as an isolation barrier between the mixing elements (paddle 25 and support rod 24) and the interior of the container 10. If desired, the sleeve 20 may be fabricated from a polymeric film with a lower seam 21 formed (e.g., via welding or thermal bonding) after the mixing elements 24, 25 are inserted into the sleeve 20, such that any of the mixing elements 24, 25 may be permanently retained by the sleeve 20. The sleeve 20 may include a reinforced aperture-defining coupling guide 18 to permit the support rod 24 to be inserted into the sleeve 20 and/or permit an external mixing mechanism (not shown) to be coupled to the support rod 24 while resisting puncture or damage of the sleeve 20. In operation, the paddle 25 and rod 24 contained within the sleeve 20 are preferably directed in a circular, oval, linear, or other appropriate path within the container 10 to stir or mix substances contained therein, without continuous rotation of the paddle 25 and the support rod 24 around a longitudinal axis of the support rod 24.

Both the container 10 and sleeve 20 preferably comprise polymeric materials suitable for economical single use (i.e., disposable) operation. In one embodiment, each of the container 10 and sleeve 20 comprises a polymeric film; in a particularly preferred embodiment, each of the container 10 and sleeve 20 comprises a substantially optically transmissive or transparent film. If desired, a substantially open external frame (not shown) may be provided to support the container 601 with associated hooks or connectors (not shown). An upper wall 14 of the container 10 further defines apertures 31, 32 serving as access ports for the admission of substances into the container 10. Each aperture or port 31, 32 preferably has an associated supply line 33, 34, sealing element 35, 36, and coupling element 37, 38. A lower wall 16 of the container 10 defines an aperture 15 adapted to receive a drain connector flange (such as any of the flanges described hereinafter), which may be joined to the container 10 by any appropriate means (e.g., welding, thermal bonding, adhesive bonding, etc.). The combination of the container 10 and flange may be called a processing receptacle.

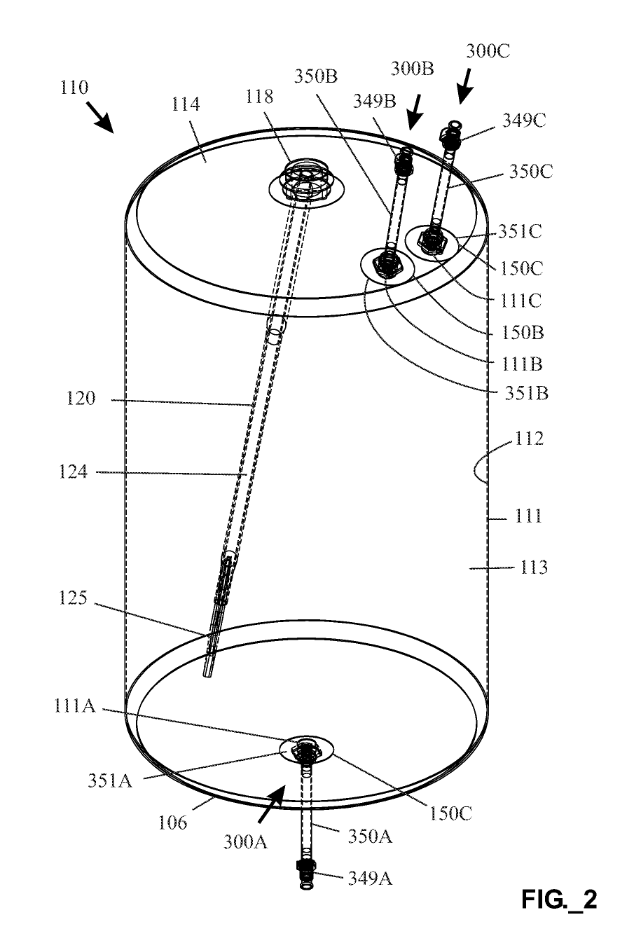

Another container 110 (with the understanding that the container 110 may refer to any suitable tank, bag, vessel, or other receptacle) arranged to receive three drain connectors 300A, 300B, 300C (which may resemble or embody any of the drain connectors disclosed hereinafter) is illustrated in FIG. 2. The container 110 is substantially cylindrical in shape has an upper surface 114, a lower surface 106, and a wall 111 having an inner surface 112 bounding an interior volume 113. The container 110 further includes a cavity-defining sealed sleeve 120 joined to the top 114 of the container 110 and protruding into the container 110. The sleeve 120 contains a mixing paddle 125 and support rod 124. The function of the sleeve 120 is to serve as an isolation barrier between the mixing elements (support rod and paddle) 124, 125 and the interior 113 of the container 110. The paddle 125 and rod 124 contained within the sleeve 125 are preferably directed in a circular, oval, linear, or other appropriate path within the container 110 to stir or mix substances contained therein. A coupling guide 118 arranged along the upper surface 114 is preferably provided to permit the support rod 124 to be inserted into the sleeve 120 without damaging the sleeve 120. One or more external mixing mechanisms or elements (not shown) is preferably provided and coupled from above to cause the support rod 124 and mixing paddle 125 to move within the interior 113 of the container 110.

The container 110 defines three apertures or ports 150A-150C each having an associated drain connector 300A-300C. Each drain connector 300A-300C preferably includes a flange 351A-351C and a hollow body or plunger 111A-111C arranged to travel within a bore of the flange 351A-351C, an associated inlet/outlet tube 350A-350C, and a coupling 349A-349C associated with the inlet/outlet tube 350A-350C. The combination of the container 110, sleeve 120, mixing elements 124, 125, and drain connectors 300A-300C may be termed a processing receptacle. In operation of the receptacle, substances are supplied to the interior 113 of the container 110 through, e.g., the upper drain connectors 300B, 300C, which may be opened for as long or short a period as desired and/or intermittently operated if desired. Substances are then processed within the container 110. Following any processing steps, a drain connector, e.g., the lower drain connector 300A, may be opened to permit processed substances to exit the container 110.

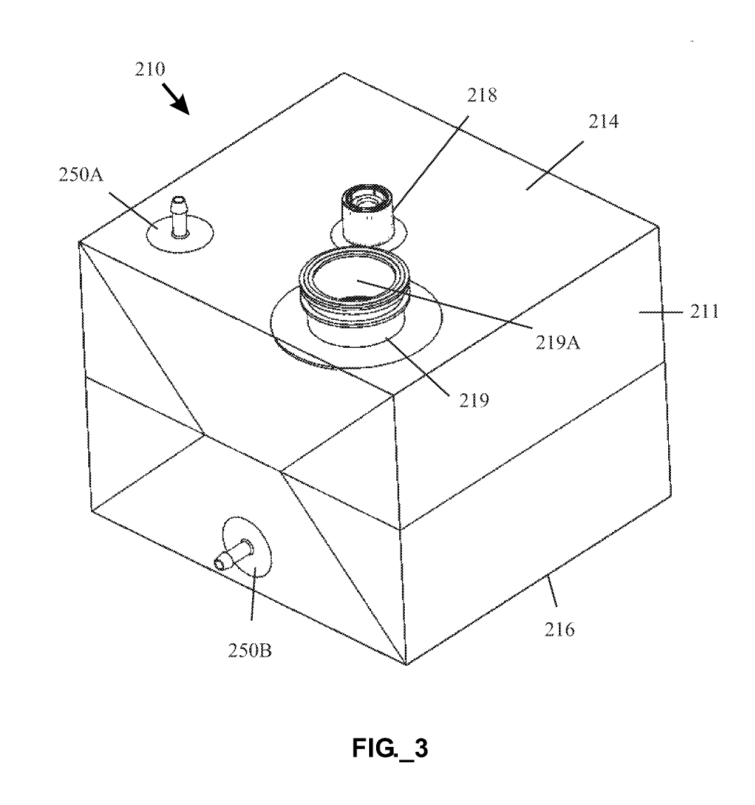

Another container 210 having ports 250A, 250B that may be embodied as drain connectors (such as any of the drain connectors disclosed hereinafter) is illustrated in FIG. 3. The container 210 is rectangular or cubic in shape with an upper wall 214, side walls 210, and a bottom wall 216. A reinforced coupling guide 218 provides an externally accessible interface arranged to receive a support rod of a mixing paddle (not shown) is affixed to the top wall of the container 210. An internal sealed sleeve (not shown) may be affixed to the coupling guide 218 and extend into the interior of the container 210 to provide an isolation barrier between any mixing elements disposed within the sleeve and any contents disposed within the interior of the container 210. A fitment 219 defining an opening 219A permitting access to the interior volume of the container 210 and arranged to receive a sealable cap (not shown) is further arranged along a top wall 214 of the container 210.

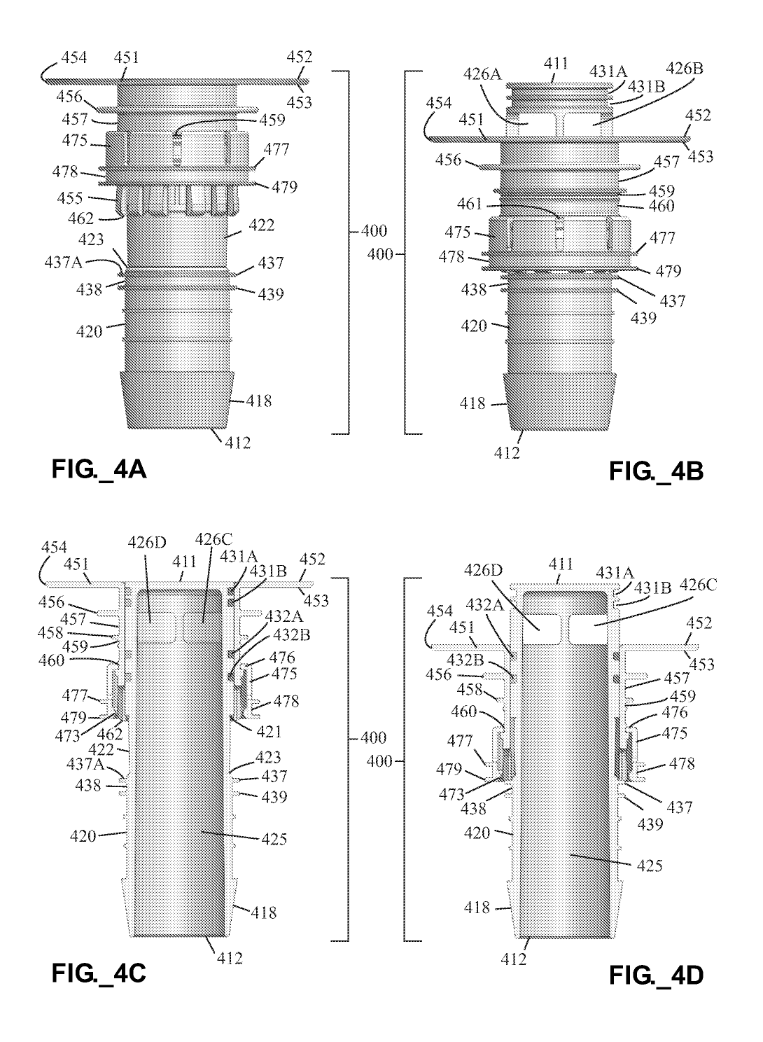

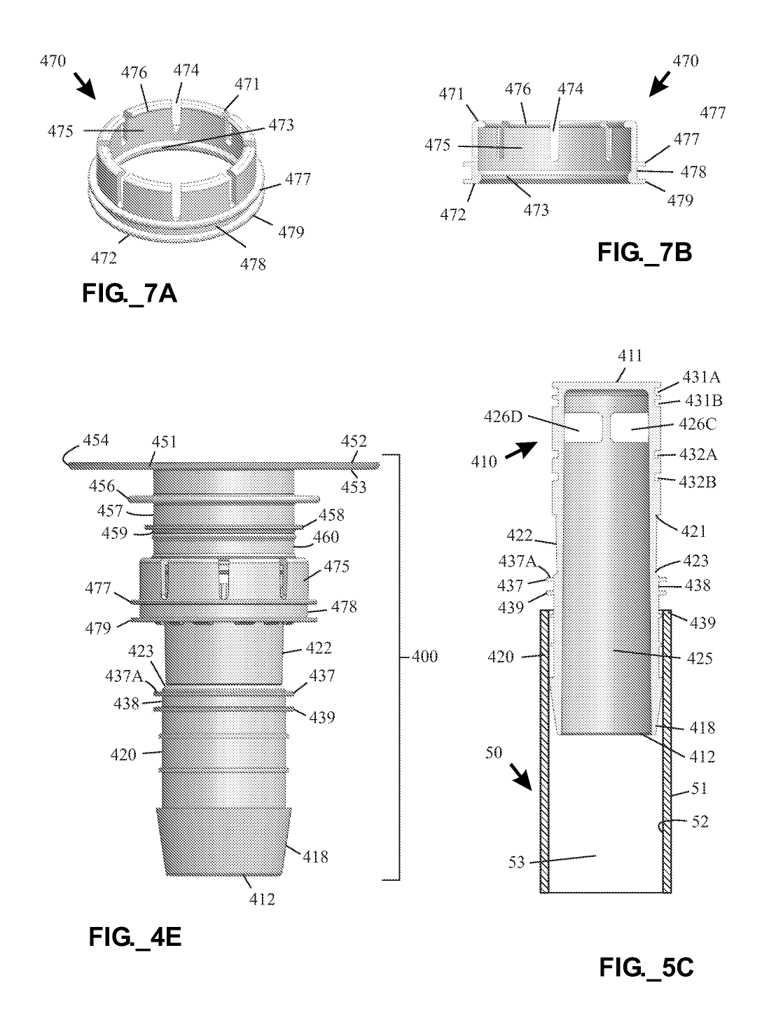

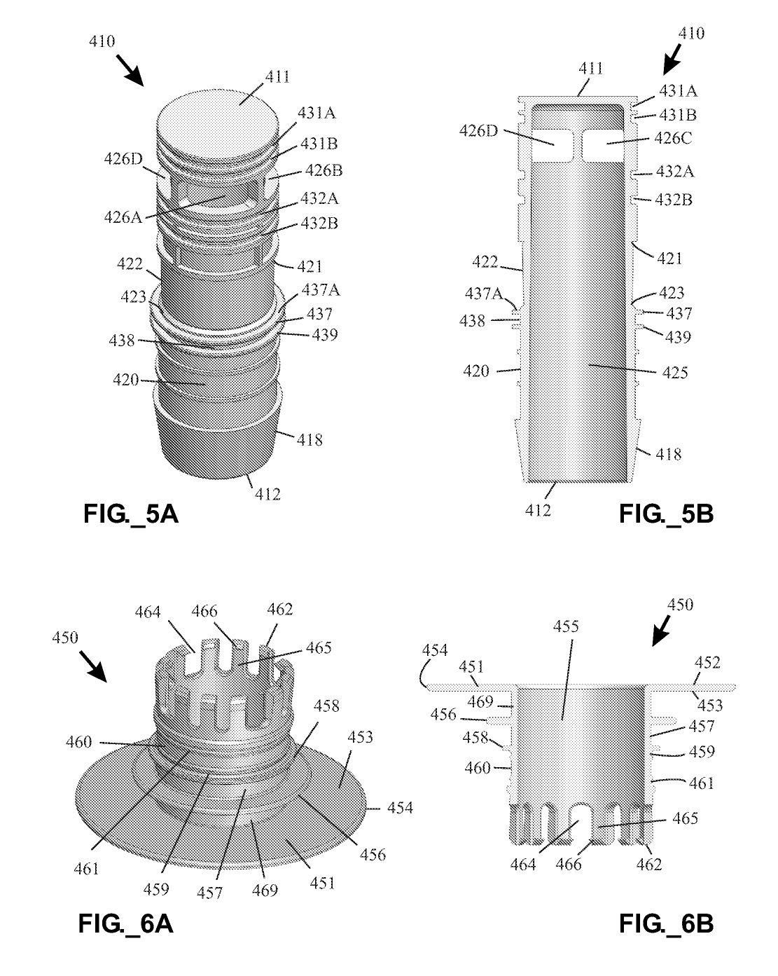

FIGS. 4A-4E illustrate a drain connector 400 including a hollow body (e.g., hollow plunger), a drain flange, and a locking element (e.g., locking collar) according to one embodiment of the present invention. The hollow body is moveable relative to and within a bore of the drain flange to affect passage of material through the drain connector Individual components of the drain connector 400 are further illustrated in FIGS. 5A-5C (illustrating the hollow body or plunger 410), FIGS. 6A-6B (illustrating the drain flange 450), and FIGS. 7A-7B (illustrating the locking collar 470).

Referring to FIGS. 5A-5B, a hollow body (e.g., hollow plunger) 410 is generally tubular in shape and includes a first closed end 411, an open second end 412, and a wall 420 (e.g., annular in shape) bounding a hollow core 425. The hollow core 425 has an approximately constant cross-sectional area or diameter along the length thereof. Multiple passages 426A-426D are defined through the wall 420 and extend from an exterior surface of the wall 420 into the hollow core 425. Two pairs of circumferential recesses 431A-431B, 432A-432B are defined above and below the passages 426A-426D, respectively, with the circumferential recesses arranged to receive circumferential sealing elements such as O-rings (not shown) arranged to provide sealing utility between the hollow body or plunger 410 and the bore of a drain flange (as shown in FIGS. 6A-6B). Utilization of pairs of sealing elements increases reliability of the resulting seal, since failure of a single sealing element will not necessarily compromise sealing integrity.

While multiple passages 426A-426C are shown as being defined through the wall 420, a hollow body 410 may only require a single passage. If desired, a multiplicity of passages 426A-426C may be defined through the wall 420 of any size suitable for an intended application. In one embodiment, the passages 426A-426C may be sized to provide straining or filtration utility. In another embodiment, the passages may be sized to permit air or other gases to be introduced from the plunger 410 into a suitable container, such as to supply oxygen to biological moieties contained therein or to furnish gaseous reactants for a desired reaction. In this vein, the adjective “drain” as applied to the term “drain connector” herein is intended to refer to the ability of such a device to modulate flow, but without being limited to modulating flow in only one direction.

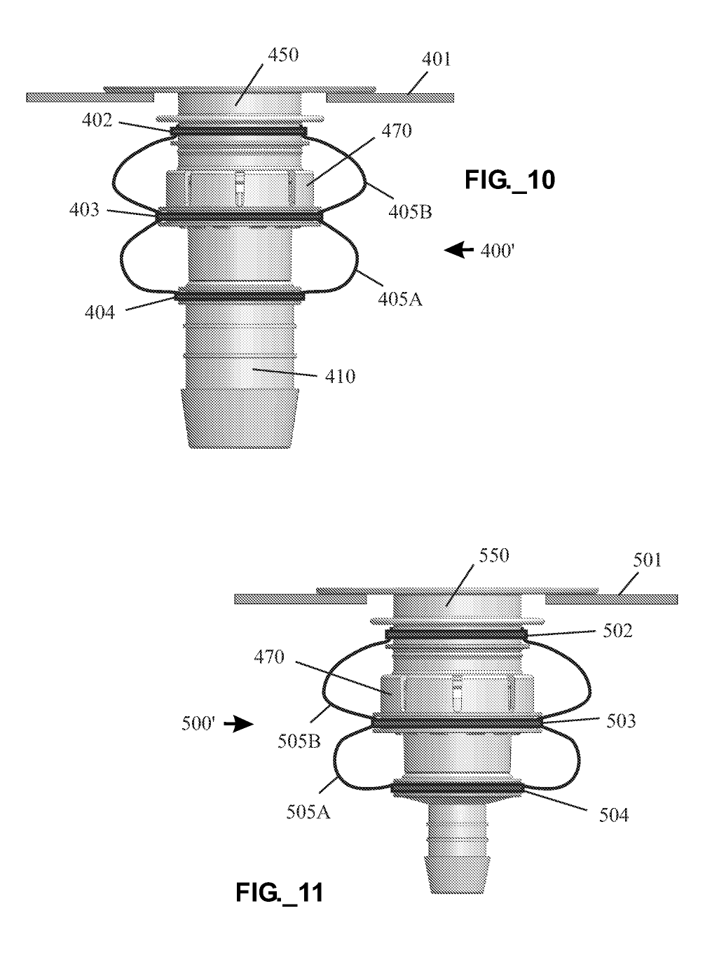

The exterior surface of the wall 420 of the hollow body 410 includes a recessed surface portion 422 with first and second detents 421, 423 arranged at top and bottom ends thereof for receiving tip portions of spring tabs of an associated drain flange (e.g., spring tab tip portions 466 of drain flange 450 illustrated in FIGS. 6A-6B) when the hollow body or plunger 410 is arranged in a closed or open position, respectively, relative to the drain flange. When the drain connector 400 is in a closed state (as shown in FIG. 4C), the spring tab tip portions 466 of the drain flange 450 contact the upper detent 421, which serves as a travel stop to prevent the hollow body 411 from traveling below the upper surface 452 of the drain flange 450 and away from the interior of a container to which the drain flange 450 is affixed. The wall 420 of the hollow body 410 further includes circumferentially projecting portions 437, 439 disposed proximate to a sealing surface portion 438 arranged to receive an external sealed jacket (such as the jacket(s) 405A-405B shown in FIG. 10) arranged to extend between exterior portions of the drain flange and the hollow body. Such a sealed jacket may be compressively retained against the sealing surface portion 438 by a compressive retention element (e.g., plastic cable tie/tie wrap or other appropriate element), with the circumferentially projecting portions 437, 439 arranged to prevent movement of the compressive retention element along the length of the wall 420.

Continuing to refer to FIGS. 5A-5B, a tapered neck portion 418 is provided for mating with an outlet tube (such as the tube 50 illustrated in FIG. 5C) proximate to the open end 412 of the hollow body 410. An upper portion of the hollow body 410 proximate to the closed end 411 is preferably sized with a maximum outer diameter that is no larger than an inner diameter of the bore of an associated drain flange, to permit insertion of the closed end 411 of the hollow body 410 into the bore of the drain flange from the exterior of a hollow container after the drain flange is affixed to a wall of the container.

FIG. 5C shows the hollow body 410 mated with an outlet tube 50 having a wall 51 and an inner surface 52 bounding a hollow interior 53. The outlet tube 50 is fitted around the tapered neck portion 418 proximate to the lower end 412 of the hollow body 410. The outlet tube 50 may be used to convey material to or from the hollow core 425 of the hollow body 410. A compressive retention element (e.g., plastic cable tie/tie wrap or other appropriate element, not shown) may optionally be fitted around the exterior of the outlet tube 50 to apply compressive force against the outlet tube 50 to retain same in position around a lower end of the hollow body 410. Sealing between the outlet tube 50 and the hollow body 410 may be further assured with adhesive, welding, or thermal bonding. The outlet tube 50 functions to conduct substances from (or alternatively, to) the hollow core 425 of the plunger 410. If desired, the outlet tube 50 may also be used to actuate the drain connector 400, such as by manual positioning of the hollow body or an outlet tube associated therewith. With the outlet tube 50 joined to the neck 418 of the hollow body or plunger 410, upward movement of the outlet tube 50 pushes the drain connector 410 into an open position, while downward movement of the outlet tube 50 draws the drain connector 400 into a closed position. As an alternative to manual operation, conventional actuating elements such as levers, rods, solenoids, or other actuators may be used to cause the drain connector 400 to cycle between the open and closed positions, or positions therebetween (e.g., to modulate flow through the drain connector). In one embodiment, an actuator for a drain connector is operatively connected to a control element receiving one or more sensor inputs, wherein the control element actuates the actuator to control operation of the drain connector responsive to signals received from the one or more sensor inputs.

The sealed jacket for a drain connector permitting the drain connector to be manipulated into various positions (as described hereinabove) ensures that contaminants cannot be introduced to the at least one circumferential sealing element from an environment exterior to the container. Utilization of such a drain connector eliminates potential need for operating a drain connector of a container in a cleanroom environment to maintaining contaminant-free conditions in the drain connector even after multiple operations thereof.

In an alternative embodiment, a hollow body similar to the hollow body 410 described above may be modified to include a first open end and an open second end. Openings arranged in the first open end and the second open end may be the same size or different sizes relative to one another. Such body with two open ends may be termed a hollow port.

Referring to FIGS. 6A-6B, a drain flange 450 includes a flange lip 451 having an upper surface 452 (defining one end of the drain flange), a lower surface 453, and a peripheral edge 454. The flange lip 451 extends radially outward from a central body portion including a wall 469 defining a bore 455. The bore 455 preferably includes a substantially constant inner dimension (e.g., diameter) to permit a hollow body (hollow plunger) to slide freely therein with associated sealing elements (e.g., O-rings) contacting an inner surface of the drain flange 450 defining the bore 455.

Along a second end 462 of the drain flange 450 are multiple spring tabs 465 separated by gaps 464, with each spring tab 465 having an associated tip portion 466 extending inward toward the bore 455. As indicated previously, each tip portion 466 is arranged to contact a recessed surface portion 422 of a hollow body 410 when the hollow body 410 is inserted into the bore 455 (as illustrated in FIGS. 4A-4E).

Along the exterior of the drain flange 450, the wall 469 includes circumferentially projecting portions 456, 458 disposed proximate to a sealing surface portion 457 arranged to receive an external sealed jacket (such as the jacket(s) 405A-405B shown in FIG. 10) arranged to extend between exterior portions of the drain flange 450 and a hollow body inserted into the bore 455 thereof. Such a sealed jacket may be compressively retained against the sealing surface portion 457 by a compressive retention element (e.g., plastic cable tie/tie wrap or other appropriate element), with the circumferentially projecting portions 456, 458 arranged to prevent movement of the compressive retention element along the length of the wall 469. The wall 469 of the drain flange 450 further includes a recessed surface portion 460 with first and second detents 459, 461 arranged and top and bottom ends thereof for receiving tip portions of spring tabs of a locking collar (e.g., spring tab tip portions 476 of locking collar 470 illustrated in FIGS. 7A-7B) when a locking collar is fitted around the exterior of the wall 469 of the drain flange 450.

Use of the at least one external sealed jacket 405A, 405B enables sterile conditions to be maintained even after operation of the drain connector, since the at least one jacket 405A, 405B prevents ingress of contaminants along the sealing surfaces between the hollow body and the bore of the drain flange. This permits the drain connector to be used as a sterile sampling apparatus and/or filling port, and to be re-used as desired without concern of introduction of contaminants following operation thereof.

Referring to FIGS. 7A-7B, a locking collar 470 for use with a drain flange 450 and associated hollow body 410 is annular in shape with an inwardly projecting ring portion 473 proximate to a first end 472, and a plurality of spring tabs 475 terminating at spring tab tip portions 476 extending inward along a second end 471, with the spring tabs separated by gaps 474. An outer surface of the locking collar 470 includes circumferentially projecting portions 477, 479 disposed proximate to a sealing surface portion 478 arranged to receive an external sealed jacket (such as the jacket(s) 405A-405B shown in FIG. 10) arranged to extend between exterior portions of the drain flange 450 and a hollow body inserted into the bore 455 thereof, with a portion of such a sealed jacket preferably arranged to engage the sealing surface portion 478 of the locking collar 470.

FIG. 4A illustrates the drain connector 400 (including the hollow body 410, drain flange 450, and locking collar 470 as illustrated in FIGS. 5A-5B, 6A-6B, and 7A-7B, respectively) in a closed and unlocked state, with the first closed end 411 of the hollow body 410 being substantially flush with the top surface 452 of the drain flange 450. The drain connector 400 is considered ‘closed’ because passage of material through the passages 426A-426D is blocked by sealing elements (not shown, but arranged for insertion into the circumferential recesses 431A-431B, 432A-432B defined above and below the passages 426A-426D) arranged for sealing engagement between the exterior of the hollow body 410 and the bore 455 of the drain flange 450. The drain connector 400 is considered ‘unlocked’ because the ring portion 473 of the locking collar 470 is separated from (e.g., disposed above) the spring tabs 465 of the drain flange 450, such that the ring portion 473 of the locking collar 470 does not press the spring tab tip portions 466 radially inward toward the recessed surface portion 422 of the hollow body 410; accordingly, the hollow body 410 may be moved upward relative to the drain flange 450 (e.g., into an open position).

FIGS. 4B and 4D illustrate the drain connector 400 in an open and locked state. The drain connector 400 is considered ‘open’ because the first closed end 411 of the hollow body 410 extended above the top surface 452 of the drain flange 450 to expose the passages 426A-426D, thereby enabling passage of material between the hollow core 425 (of the hollow body 410) and an interior of a container (not shown) to which the drain flange 450 may be affixed. The drain connector 400 is considered ‘locked’ because the ring portion 473 of the locking collar 470 (proximate to the lower end 472 thereof) is pressed against the spring tabs 465 of the drain flange 450, thereby pressing the spring tab tip portions 466 radially inward toward the recessed surface portion 422 (e.g., into the lower detent 423 thereof), thereby locking the position of the hollow body 410 relative to the drain flange 450, and preventing the hollow body 410 from moving downward (e.g., into a closed position).

FIGS. 4C and 4E illustrate the drain connector 400 (in cross-sectional view) in a closed and locked state, with the first closed end 411 of the hollow body 410 being substantially flush with the top surface 452 of the drain flange 450. The drain connector 400 is considered ‘locked’ because the ring portion 473 of the locking collar 470 (proximate to the lower end 472 thereof) is pressed against the spring tabs 465 of the drain flange 450, thereby pressing the spring tab tip portions 466 radially inward toward the recessed surface portion 422 (e.g., into the upper detent 421 thereof), thereby locking the position of the hollow body 410 relative to the drain flange 450, and preventing the hollow body 410 from moving upward (e.g., into an open position).

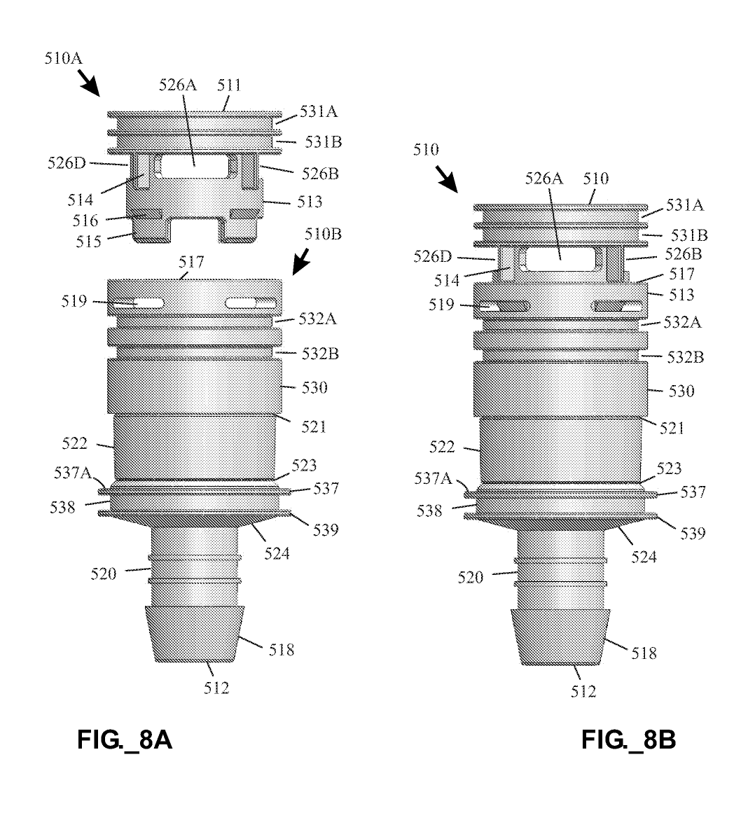

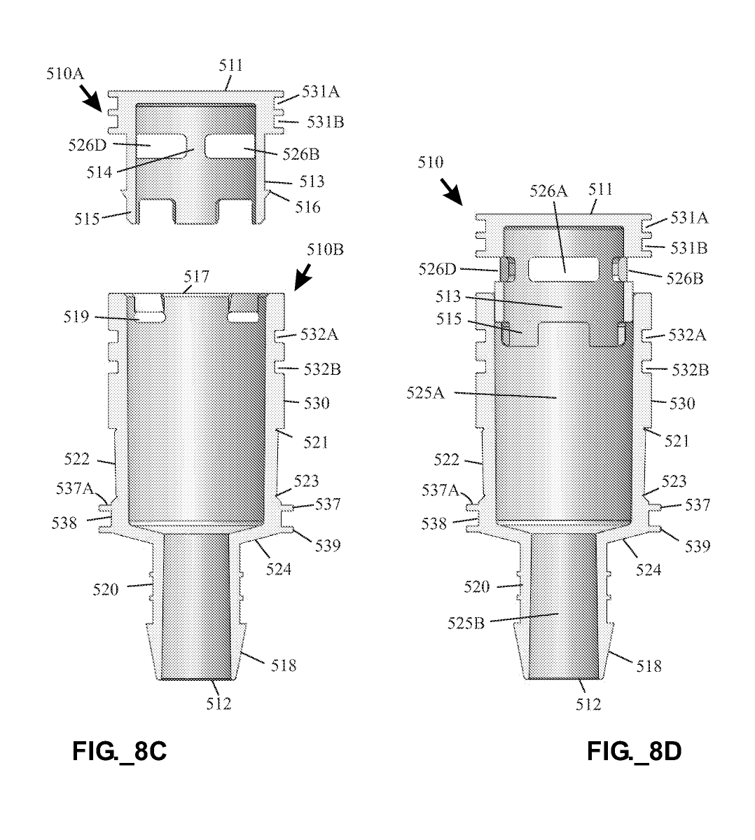

An alternative hollow body 510 arranged for use with the same drain flange 450 and locking collar 470 described hereinabove may be fabricated from two portions 510A, 510B, and is shown in FIGS. 8A-8D (with FIGS. 8A, 8C providing assembly views of portions 510A-510B, and with FIGS. 8B, 8D illustrating the assembled hollow body 510). The hollow body 510 is preferably fabricated by molding (e.g., injection molding) in two portions 510A, 510B due to the complex character of the resulting body 510 and the difficulty of otherwise fabricating the hollow body 510 in one piece. The hollow body 510 (or hollow plunger) including an upper hollow core portion 525A with a first internal cross-sectional area or diameter (bounded by upper wall portion 530), and a lower hollow core portion 525B with a second, smaller internal cross-sectional area or diameter (bounded by lower wall portion 520). The lower wall portion 520 has a smaller external area or diameter than the upper wall portion 530, thereby permitting a smaller outlet tube (not shown) to be fitted around the tapered neck portion 518 proximate to the open end 512 of the hollow body 520.

A first (upper) portion 510A of the hollow body 510 includes a first closed end 511, two circumferential recesses 531A-531B arranged to receive sealing elements (e.g., O-rings, not shown), and an annular wall portion 513 including posts 514 separating multiple passages 526A-526D defined through the wall portion 513 and extending into a hollow interior of the first portion 510A. The circumferential recesses 531A-531B are disposed between the passages 526A-526D and the first closed end 511. Downwardly extending tab portions 515 extend downward from the annular wall portion 513, and radially extending tabs 516 are arranged to extend radially outward from the annular wall portion 513 above the downwardly extending tab portions 515.

A second (lower) portion 510B of the hollow body 510 includes a lower wall portion 520, with a reducing wall portion 524 disposed between the upper wall portion 530 and the lower wall portion 520. The upper wall portion 530 terminates at an upper end 517, with the upper interior of the wall portion 530 defining angled recesses 518 leading to apertures 519 (extending through the upper wall portion 530). The recesses 518 are sized and positioned to receive the downwardly extending tab portions 515, with the apertures 519 being sized and positioned to receive the radially extending tabs 516. Upon insertion of the tab portions 515 of the first (upper) portion 510A into the upper end 517 of the second (lower) portion 510B, the downwardly extending tab portions 515 are guided by the angled recesses 519 to cause the radially extending tabs 516 to fit into the apertures 519 to affix the upper portion 510A to the lower portion 510B.

Continuing to refer to FIGS. 8A-8D, an outer surface of the upper wall portion 530 includes two circumferential recesses 532A, 532B arranged to receive circumferential sealing elements such as O-rings (not shown) arranged to provide sealing utility between the hollow body or plunger 510 and the bore of a drain flange (as shown in FIGS. 6A-6B). The exterior surface of the upper wall portion 530 further includes a recessed surface portion 522 with first and second detents 521, 523 arranged at top and bottom ends thereof for receiving tip portions of spring tabs of an associated drain flange (e.g., spring tab tip portions 466 of drain flange 450 illustrated in FIGS. 6A-6B) when the hollow body or plunger 510 is arranged in a closed or open position, respectively, relative to the drain flange.

The upper wall portion 530 further includes circumferentially projecting portions 537, 539 disposed proximate to a sealing surface portion 538 arranged to receive an external sealed jacket (such as the jacket(s) 505A-505B shown in FIG. 11) arranged to extend between exterior portions of the drain flange and the hollow body. Such a sealed jacket may be compressively retained against the sealing surface portion 538 by a compressive retention element (e.g., plastic cable tie/tie wrap or other appropriate element), with the circumferentially projecting portions 537, 539 arranged to prevent movement of the compressive retention element along the length of the upper wall portion 530. An upper surface 537A of the upper circumferentially projecting portion 537 further serves as a travel stop to contact the lower end 462 of the drain flange 450 when the drain connector 400 is in a fully open position (as shown in FIG. 4D), thereby preventing the hollow body 411 from traveling too far past the upper surface 452 of the drain flange 450 and into the interior of a container to which the drain flange 450 is affixed.

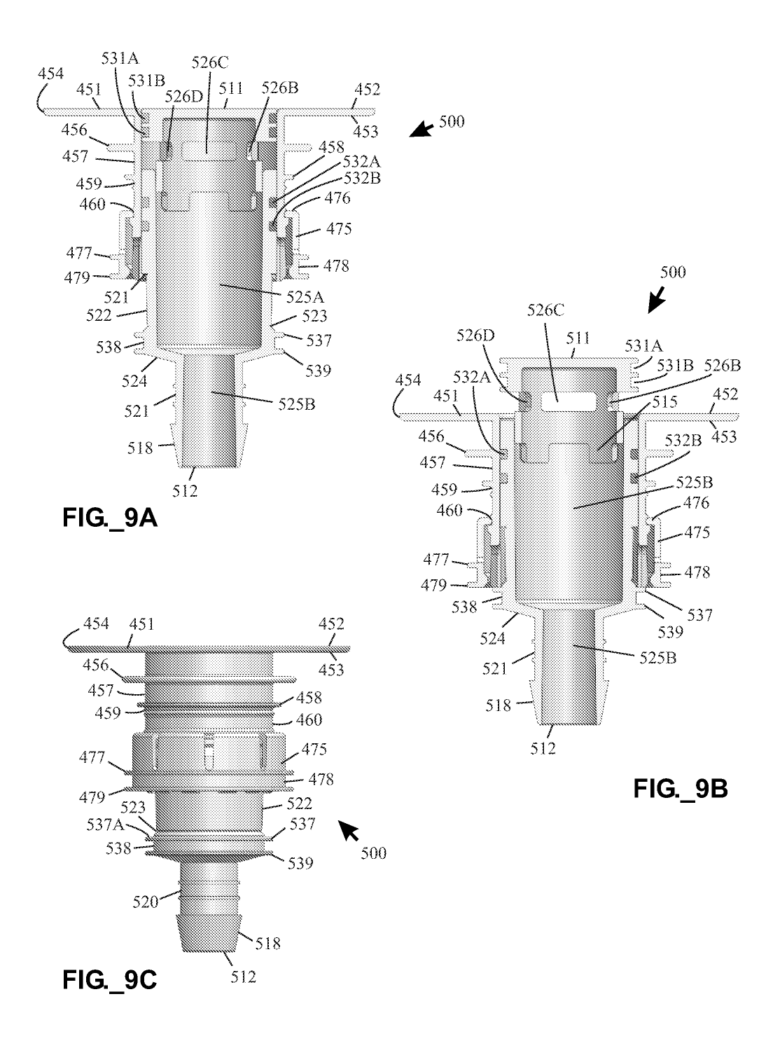

A drain connector 500 including the hollow body 510, with the drain flange 450 and locking collar 470 as utilized with the preceding drain connector 400 (e.g., illustrated in FIGS. 4A-4E) is illustrated in FIGS. 9A-9C. That is, the upper portion of the hollow body 510 is compatible in size and shape with the same drain flange 450 and locking collar 470, and has an maximum outer diameter that is no larger than an inner diameter of the bore 455 of the drain flange 450, to permit insertion of the closed end 511 of the hollow body 510 into the bore 455 from the exterior of a hollow container after the drain flange 450 is affixed to a wall thereof. A primary functional difference between the hollow body 510 of the present embodiment and the hollow body 410 of the preceding embodiment is that the hollow body 510 has a lower (e.g., outlet) end 512 and tapered neck portion 518 that are smaller than corresponding components of the hollow body 410 of the preceding embodiment, therefore allowing the hollow body 510 to be mated with outlet conduits of smaller size.

It is to be recognized that any number of different hollow bodies having compatible upper portions but having different lower portions (for mating with conduits of differing sizes) may be used with drain flanges of the same size and type (e.g., as affixed to a wall of a container). After one or more drain flanges of unitary size are attached to a container, a hollow body of desired outlet size may be individually selected for each drain flange from a plurality of hollow bodies having different outlet sizes, and the selected hollow body of desired outlet size may be inserted in each corresponding drain flange with at least one circumferential sealing element disposed between the drain flange and the hollow body. The container may be sterilized together with the at least one drain flange and the hollow body inserted into each drain flange of the at least one drain flange. At least one sealed jacket may be applied extending between exterior portions of the drain flange and the hollow body to provide a barrier arranged to inhibit passage of contaminants to the at least one circumferential sealing element from an environment exterior to the container. The processing bag or container may be packaged to maintain sterile and/or contaminant-free conditions. Insertion of a hollow plunger or port into a drain flange may be accomplished in a clean room or comparable ultra-clean environment to minimize introduction of contaminants into a processing bag or container. The combination of a processing bag or processing container, one or more drain flanges, and one or more hollow bodies may be packaged together in a package adapted to maintain sterile and/or substantially contaminant-free conditions within the package.

In one embodiment, multiple hollow bodies or plungers and/or hollow ports may be provided with equally sized and shaped portions for mating with a unitary drain flange, but other portions of the hollow plungers and/or hollow ports may differ in at least one of core size, connection type, connection size, hollow body material type, circumferential sealing material type, and/or other characteristics, to provide desired connection utility, flow utility, sealing utility, and/or compatibility with processed materials. A processing container or processing bag may be manufactured with one or more drain flanges (as described herein) affixed or otherwise mounted thereto, and thereafter hollow plungers and/or hollow ports of compatible type (e.g., exterior dimensions along at least an portion insertable into a drain flange) but varying characteristics may be mated with such drain flanges. Multiple hollow plungers and/or hollow ports of compatible type but varying characteristics may be available for selection by a user or mechanized apparatus during manufacture of a container or bag having one or more drain flanges. This enables reduction in lead time for manufacturing customized processing containers or processing bags, and also minimizes need to maintain inventories of entire drain connectors of multiple types, since hollow plungers and/or hollow ports need not be specific to, or integrally assembled with, individual drain flanges. In one embodiment, a hollow plunger and/or a hollow port having a large core size may be selected to provide rapid draining utility. Alternatively, hollow bodies with smaller core size may be selected to facilitate periodic extraction of small sample volumes.

FIGS. 9A and 9C illustrate the drain connector 500 in a closed and locked state, with the first end 511 of the hollow body 510 arranged substantially flush with the upper surface 452 of the drain flange 4590. The hollow body 510 is arranged within the bore 455 of the drain flange 450, with the circumferential recesses 531A-531B, 532A-532B arranged to receive circumferential sealing elements such as O-rings (not shown) to provide sealing utility between the hollow body or plunger 510 and the bore 455. The drain connector 500 is considered ‘closed’ because passage of material through the passages 526A-526D is blocked by sealing elements (not shown, but arranged for insertion into the circumferential recesses 531A-531B, 532A-532B defined above and below the passages 526A-526D) arranged for sealing engagement between the exterior of the hollow body 510 and the bore 455 of the drain flange 450. The drain connector 500 is considered ‘locked’ because the ring portion 473 of the locking collar 470 (proximate to the lower end 472 thereof) is pressed against the spring tabs 465 of the drain flange 450, thereby pressing the spring tab tip portions 466 radially inward toward the recessed surface portion 522 (e.g., into the upper detent 521 thereof), thereby locking the position of the hollow body 510 relative to the drain flange 450, and preventing the hollow body 510 from moving upward (e.g., into an open position).

FIG. 9B illustrates the drain connector 500 in an open and locked state. The drain connector 500 is considered ‘open’ because the first closed end 511 of the hollow body 510 extended above the top surface 452 of the drain flange 450 to expose the passages 426A-426D, thereby enabling passage of material between the hollow core 525 (of the hollow body 510) and an interior of a container (not shown) to which the drain flange 450 may be affixed. The drain connector 500 is considered ‘locked’ because the ring portion 473 of the locking collar 470 (proximate to the lower end 472 thereof) is pressed against the spring tabs 465 of the drain flange 450, thereby pressing the spring tab tip portions 466 radially inward toward the recessed surface portion 522 (e.g., into the lower detent 523 thereof), thereby locking the position of the hollow body 510 relative to the drain flange 450, and preventing the hollow body 510 from moving downward (e.g., into a closed position).

FIG. 10 illustrates a hollow body or plunger 410, drain flange 450, and locking collar 470 of a drain connector 400′ (similar to the drain connector 400 shown in FIGS. 4A-4E), with the drain flange 450 joined to a wall 401 of a container, and further including at least one external sealed jacket (e.g., whether as a single jacket 405 (preferred), or optionally as two portions 405A, 405B) engaged to an external portion of each of the hollow body or plunger 410, the drain flange 450, and the locking collar 470. The at least one external sealed jacket 405A, 405B may be compressively retained against (i) the sealing surface portion 438 of the hollow body 410 with a first compressive retention element 404 (e.g., plastic cable tie/tie wrap or other appropriate element), (ii) the sealing surface portion 457 of the drain flange 450 with a second compressive retention element 402, and (iii) the sealing surface portion 478 of the locking collar 470 with a third compressive retention element 403. The at least one external sealed jacket 405A, 405B may be formed of any desirable material such as flexible polymeric film, silicone, spunbonded polyolefin, or the like arranged to prevent or inhibit passage of contaminants (which is preferably (but not necessarily) substantially optically transmissive or transparent in character) and is preferably sized and shaped so as not to restrict movement of the hollow body or plunger 410 relative to the drain flange 450, or of the locking collar 470 relative to the drain flange 450, within the desired ranges of motion for such elements. In one embodiment, the at least one external sealed jacket comprises bellows.

FIG. 11 illustrates a hollow body or plunger 510, drain flange 450, and locking collar 470 of a drain connector 500′ (similar to the drain connector 500 shown in FIGS. 9A-9C), with the drain flange 450 joined to a wall 501 of a container, and further including at least one external sealed jacket (e.g., whether as a single jacket 505 (preferred), or optionally as two portions 505A, 505B) engaged to an external portion of each of the hollow body or plunger 510, the drain flange 450, and the locking collar 470. The at least one external sealed jacket 505A, 505B may be compressively retained against (i) the sealing surface portion 538 of the hollow body 510 with a first compressive retention element 504 (e.g., plastic cable tie/tie wrap or other appropriate element), (ii) the sealing surface portion 457 of the drain flange 450 with a second compressive retention element 502, and (iii) the sealing surface portion 478 of the locking collar 470 with a third compressive retention element 503. The at least one external sealed jacket 505A, 505B is preferably sized and shaped so as not to restrict movement of the hollow body or plunger 510 relative to the drain flange 450, or of the locking collar 470 relative to the drain flange 450, within the desired ranges of motion for such elements.

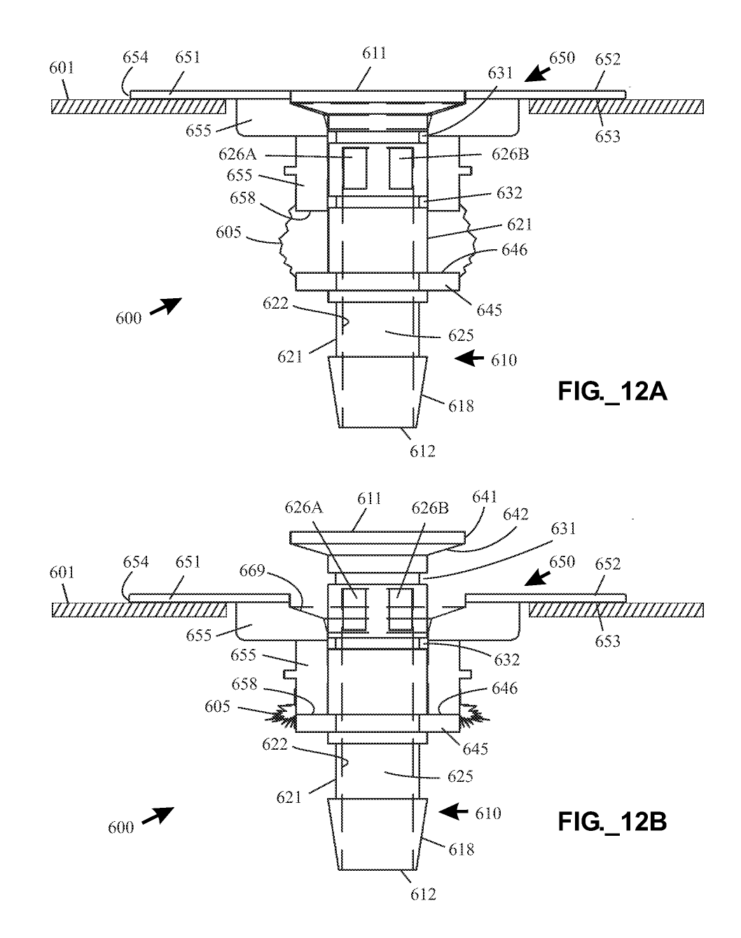

Another embodiment of a drain connector 600 devoid of a locking collar and including a hollow body or plunger 610 with a flared end portion arranged to cooperate with a drain flange 650 is illustrated in FIGS. 12A-12B. The drain connector 600 includes a hollow body or plunger 610 that is moveable within the bore of a drain flange 650. The hollow body or plunger 610 has a body that is preferably tubular in shape, a first closed end 611, a second open end 612, and a wall 621 having an interior surface 622 defining a hollow core 625 in fluid communication with the open end 612. Multiple passages 626A-626B are defined through the wall 621 and into the hollow core 625. The wall 621 further defines two circumferential recesses 631, 632 adjacent to the passages 626A-626B. Specifically, the passages 626A-626B are disposed between the recesses 631, 632, with the recesses 631, 632 being sized to retain sealing elements (e.g., O-rings, not shown) to provide sealing utility between the hollow body or plunger 610 and the bore of the drain flange 650.

The first closed end 611 of the hollow body or plunger 610 includes a flared portion 641 that serves as a travel stop for the hollow plunger 610 when it moves (e.g., downward) into the bore of the drain flange 650. The flared portion or travel stop 641 includes an outer tapered surface 642 sized and shaped to mate against a corresponding inner tapered surface 669 of the drain flange 650. At the opposite end of the hollow body or plunger 610, the wall 621 leads to a tapered neck portion 618 intended to mate with an outlet tube (not shown). A radially extending element 645 having an upper travel stop surface 646 is further affixed to an exterior of the hollow body or plunger 610.

The drain flange 650 includes a flange lip 651 having an upper surface 652, a lower surface 653, and a peripheral edge 654. As illustrated, the flange lip 651 is affixed to a wall 601 of a container. The flange lip 651 extends outward from the flange body 655, which defines a bore (arranged to receive the hollow body or plunger 610) and a tapered upper surface portion 669. Aside from the tapered upper surface portion 669, the bore of the drain flange 650 preferably has substantially constant interior dimensions to permit the hollow body or plunger 610 to slide freely therein, with associated sealing elements (not shown) retained by the circumferential recesses 631, 632 contacting the bore surface of the drain flange 650. The flange body 655 includes an annular lower body portion 656 including a lower surface 658.

An external sealed jacket 605 extends between an exterior of the lower body portion 656 and the radially extending element 645, with the jacket 605 providing a barrier arranged to inhibit passage of contaminants to circumferential sealing elements (not shown) disposed within the circumferential recesses 631, 632 from an environment exterior to the container 601 to which the drain connector 600 is affixed. The external sealed jacket 605 may be affixed to the lower body portion 656 and the radially extending element 645 by any suitable means, such as compressive elements (e.g., cable ties, clamps, or the like), welding, thermal bonding, and/adhesives, and fabricated of any suitably flexible material arranged to prevent passage of contaminants. The sealed jacket 605 should further be sized and positioned to permit the hollow body or plunger 610 to move over a desired range of travel relative to the drain flange 650.

FIG. 12A shows the drain connector 600 in a closed state, with the first closed end 611 of the hollow body or plunger 610 arranged substantially flush against the upper surface 652 of the drain flange 650. Passage of fluid through the passages 626A, 626B is blocked by sealing engagement between sealing elements (not shown) disposed within circumferential recesses 631, 632 between the hollow body or plunger 610 and the bore of the drain flange 650.

FIG. 12B shows the drain connector 600 in an open state, with the first closed end 611 of the hollow body or plunger 610 disposed significantly above the upper surface 652 of the drain flange 650, to expose the passages 626A, 626B and thereby open a fluid pathway for flow of material between the hollow core 625 of the hollow plunger 610 and an interior of a container 601 to which the drain flange 650 is affixed. Since the upper surface 646 of the radially extending element 645 is positioned as a travel stop to contact the lower surface 658 of the annular lower body portion 656, further upward travel of the hollow body or plunger 610 (e.g., into the body of the container to which the drain flange 650 is affixed) is prevented.

One or more sensors of various types may be incorporated into the flange and/or plunger to monitor at least one characteristic of a substance contained or flowing within the drain connector. Temperature, pH, conductivity, and pressure are examples of desirable characteristics of substances to be sensed or monitored with appropriate sensors.

While various embodiments disclosed herein illustrate plungers having perimeters that are substantially circular in shape, and likewise drain flange apertures that are substantially circular in shape, it is to be understood that such embodiments are intended to be illustrative only and the invention is not limited to particular shapes. Plungers and flanges having circular or oval shapes are preferred, but other shapes may be used.

Any of the various drain connectors described herein may be affixed to a container (e.g., tank, bag, vessel, or other receptacle, such as may be used for material storage and/or processing, including bioprocessing), optionally including one or more stirring or agitating elements, and utilized to process and/or store one or more materials within the container.

Containers including drain connectors as described herein may be put to various desirable uses. In one embodiment, a container may serve as a processing receptacle useful to mix and/or react industrial chemicals. In a first method step, at least one material is supplied added to a container as described herein. In a second method step, the at least one material is processed within the container. In a third method step, the at least one processed material is drained from the container through a drain connector as described herein. In an optional method step, one or more materials may be supplied to the container through the drain connector prior to the draining step. Such a step may include the supply of a gas such as oxygen or air to assist in aerating or facilitating a chemical reaction of materials disposed within the container.

In another embodiment, a container as described herein may be used to assist in pharmaceutical development, formulation, or manufacture. In a first method step, at least one material selected from: drug precursor materials, therapeutic agents, binding materials, bulk materials, coloring agents, flavoring agents, stabilizing agents, preservatives, and reagents is added to a container. In a second method step, the at least one material is processed (e.g., mixed and/or reacted) within the container. In a third method step, the at least one processed material is drained from the container through a drain connector as described herein. In an optional method step, one or more materials (e.g., including gases) may be supplied to the container through the drain connector prior to the draining step.

In another embodiment, a container as described herein may be used to process biological materials. In a first method step, at least one of various biological materials is added to a container. Non-biological materials may also be added if desired for a particular application. In a second method step, the at least one biological material is processed (e.g., mixed, reacted, and/or fermented) within the container. In a third method step, the at least one processed material is drained from the container through a drain connector as described herein. In an optional method step, one or more materials (e.g., including gases) may be supplied to the container through the drain connector prior to the draining step.

In another embodiment, a container as described herein may be used to process semiconductor precursor and/or processing materials. For example, wet solutions may be combined with abrasive materials to yield chemical mechanical polishing or planarization (CMP) slurries. In a first method step, at least one semiconductor precursor and/or processing material is added to a container. In a second method step, the at least one semiconductor precursor and/or processing material is processed within the container. In a third method step, the at least one processed material is drained from the container through a drain connector as described herein. In an optional method step, one or more materials (e.g., including gases) may be supplied to the container through the drain connector prior to the draining step.

Any of the various features and elements as disclosed herein may be combined with one or more other disclosed features and elements unless indicated to the contrary herein.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

### INDUSTRIAL APPLICABILITY

Devices and methods as disclosed herein are useful in industry, e.g., for aiding the processing (e.g., mixing and/or reacting) of various substances in laboratory and industrial settings.

1.-19. (canceled)

20. A drain connector arranged for mounting to a container having an interior volume, the drain connector comprising:
a drain flange defining a bore, the drain flange having a radially extending flange lip adapted for mounting to a wall of said container;
a hollow body arranged to slide within the bore to move between a first position to a second position, wherein the first position permits passage of material to or from the interior volume, and the second position inhibits passage of material to or from the interior volume; and
at least one circumferential sealing element disposed between the drain flange and the hollow body;
wherein the drain connector further comprises at least one of the following elements (a) and (b):
(a) a moveable locking collar that is selectively operable to maintain the hollow body relative to the drain flange in the first position, and operable to maintain the hollow body relative to the drain flange in the second position; and
(b) at least one flexible sealed jacket extending between an exterior portion of the drain flange and an exterior portion of the hollow body to provide a barrier arranged to inhibit passage of contaminants to the at least one circumferential sealing element from an environment exterior to the container.

21. The drain connector according to claim 20, comprising a moveable locking collar that is selectively operable to maintain the hollow body relative to the drain flange in the first position, and operable to maintain the hollow body relative to the drain flange in the second position.

22. The drain connector according to claim 20, comprising at least one flexible sealed jacket extending between an exterior portion of the drain flange and an exterior portion of the hollow body to provide a barrier arranged to inhibit passage of contaminants to the at least one circumferential sealing element from an environment exterior to the container.

23. The drain connector according to claim 20, comprising (a) a moveable locking collar that is selectively operable to maintain the hollow body relative to the drain flange in the first position, and operable to maintain the hollow body relative to the drain flange in the second position, and (b) at least one flexible sealed jacket extending between an exterior portion of the drain flange and an exterior portion of the hollow body to provide a barrier arranged to inhibit passage of contaminants to the at least one circumferential sealing element from an environment exterior to the container.

24. The drain connector according to claim 22, wherein the at least one flexible sealed jacket is retained against an external portion of the drain flange, is retained against an external portion of the hollow body, and is retained against an external portion of the locking collar.

25. The drain connector according to claim 21, wherein the drain flange comprises a first plurality of spring tabs disposed adjacent to at least one exterior surface of the hollow body, and wherein the locking collar is positionable to bias the first plurality of spring tabs to compressively engage a portion of the hollow body.

26. The drain connector according to claim 25, wherein the hollow body comprises at least one feature arranged to receive portions of the first plurality of spring tabs.

27. The drain connector according to claim 26, wherein the at least one feature comprises a first feature arranged as a first travel stop to inhibit motion of the hollow body in a first direction, and a second feature arranged as a second travel stop to inhibit motion of the hollow body in a second direction.

28. The drain connector according to claim 20, wherein the drain flange is affixed to a wall of a container defining an interior volume, and a portion of the hollow body is arranged to travel into the interior volume when the hollow body is arranged in the first position.

29. The drain connector according to claim 20, wherein the at least one circumferential sealing element comprises at least one first and at least one second circumferential sealing element, and the hollow body includes a closed end proximate to the radially extending flange lip, an open end distal from the radially extending flange lip, and an exterior surface defining at least one passage that extends into an open core of the hollow body, wherein the at least one passage is disposed between the at least one first and the at least one second circumferential sealing element.

30. The drain connector according to claim 20, wherein each of the hollow body and the drain flange comprises polymeric material.

31. The drain connector according to claim 20, wherein the hollow body comprises a closed end that is arranged substantially flush with a top surface of the drain flange when the hollow body is arranged in the second position.

32. A processing bag comprising a polymeric film material and a drain connector according to claim 20 mounted to a wall of said processing bag.

33. The processing bag according to claim 32, wherein the drain connector is mounted to a bottom wall of said processing bag, wherein the flange lip comprises an upper surface and a lower surface, and wherein the lower surface of the flange lip is attached to the bottom wall of said processing bag.

34. A method utilizing a drain connector mounted to a container having an interior volume, the drain connector comprising a drain flange defining a bore, a hollow body arranged to slide within the bore to move between a first position to a second position, wherein the first position permits passage of material to or from the interior volume, and the second position inhibits passage of material to or from the interior volume, and at least one circumferential sealing element disposed between the drain flange and the hollow body, the method comprising:
moving the hollow body relative to the drain flange from the second position to the first position; and
operating a moveable locking collar to maintain the hollow body relative to the drain flange in the first position.

35. The method according to claim 34, further comprising unlocking the locking collar, moving the hollow body relative to the drain flange from the first position to the second position, and operating the locking collar to maintain the hollow body relative to the drain flange in the second position.

36. The method according to claim 34, wherein the drain flange comprises a first plurality of spring tabs disposed adjacent to at least one exterior surface of the hollow body, and the locking collar is operable to bias the first plurality of spring tabs to compressively engage a portion of the hollow body.

37. A method of fabricating a container for processing substances and comprising an interior volume, the method comprising:
affixing at least one drain flange to a wall of the container, the at least one drain flange defining a bore of predetermined size;
individually selecting for each drain flange of the at least one drain flange, from a plurality of hollow bodies having different outlet sizes, a hollow body of desired outlet size and arranged to move within the bore to selectively affect passage of material to or from the interior volume;
for each drain flange of the at least one drain flange, inserting the selected hollow body of desired outlet size into the bore, with at least one circumferential sealing element disposed between the drain flange and the hollow body; and
applying at least one sealed jacket extending between an exterior portion of the drain flange and an exterior portion of the hollow body to provide a barrier arranged to inhibit passage of contaminants to the at least one circumferential sealing element from an environment exterior to the container.

38. The method according to claim 37, further comprising sterilizing the container together with the at least one drain flange and the hollow body inserted into each drain flange of the at least one drain flange.

39. The method according to claim 37, wherein:
the hollow body is arranged to slide within the bore to move between a first position to a second position, wherein the first position permits passage of material to or from the interior volume, and the second position inhibits passage of material to or from the interior volume; and
the method further comprises applying a moveable locking collar that is selectively operable to maintain the hollow body relative to the drain flange in the first position, and operable to maintain the hollow body relative to the drain flange in the second position.

40. The method according to claim 37, wherein each hollow body of the plurality of hollow bodies includes at least an upper portion with a maximum outer diameter that is no larger than an inner diameter of the bore of the corresponding drain flange.

41. A method utilizing a drain connector mounted to a container having an interior volume, the drain connector comprising drain flange defining a bore, a hollow body arranged to move within the bore from (i) a first position that permits passage of material to or from the interior volume to (ii) a second position that inhibits passage of material to or from the interior volume, and at least one circumferential sealing element disposed between the drain flange and the hollow body, the method comprising:
blocking passage of contaminants to the at least one circumferential sealing element from an environment exterior to the container utilizing at least one sealed jacket extending between an exterior portion of the drain flange and an exterior portion of the hollow body to provide a barrier arranged to block said passage of contaminants; and
moving the hollow body relative to the drain flange between the second position and the first position, wherein the sealed jacket is arranged to permit said movement of the hollow body while maintaining said barrier arranged to block said passage of contaminants.
